(19) United States
(12) Patent Application Publication
(10) Pub. No.: US 2002/0197033 A1
(43) Pub. Date: Dec. 26, 2002

(54) Separable optical fiber ribbon having a tape with a preferential splitting direction and associated methods of fabricating and splitting the optical fiber ribbon

(76) Inventor: Naren I. Patel, Hickory, NC (US)

Correspondence Address: CORNING CABLE SYSTEMS LLC, P O BOX 489, HICKORY, NC, 28603, US

(21) Appl. No.: 09/886,571

(22) Filed: Jun. 21, 2001

(51) Int. Cl. G02B 6/44

(52) U.S. Cl. 385/114

(57) ABSTRACT

An optical fiber ribbon is provided that includes a tape having a preferential splitting direction to facilitate the separation of the optical fiber ribbon into subsets having a desired number of optical fibers. The optical fiber ribbon includes a plurality of optical fibers, either discrete optical fibers or optical fibers disposed within a common coating. The tape is attached to the optical fibers, either directly or to the common coating, such that the preferential splitting direction extends parallel to the optical fibers in a lengthwise direction. The resulting optical fiber ribbon can be readily separated into subsets having predetermined numbers of optical fibers since the preferential splitting direction of the tape will guide the separation of the optical fiber ribbon. Associated methods of fabricating and splitting the optical fiber ribbon are also provided.

### FIELD OF THE INVENTION

The present invention relates generally to optical fiber ribbons and, more particularly, to optical fiber ribbons designed to facilitate their separation into a plurality of optical fiber ribbon subsets.

### BACKGROUND OF THE INVENTION

Optical fiber ribbons are utilized in a wide variety of applications in which multiple optical fibers are required. For example, fiber optic cables frequently include a plurality of optical fiber ribbons. Optical fiber ribbons 10 include a plurality of optical fibers 12 disposed side-by-side in a planar relationship and surrounded by a common matrix coating 14, such as an ultraviolet (UV) light curable acrylate material, as shown in FIG. 1. Each fiber 12 of an optical fiber ribbon 10 generally includes a silica-based core that is operative to transmit light and is surrounded by silica-based cladding having a lower index of refraction than the core. In FIG. 1, the core and the cladding are collectively designated as 16. A soft primary coating surrounds the cladding, and a relatively rigid secondary coating surrounds the primary coating. Also in FIG. 1, the primary and secondary coatings are collectively designated as 18. Although the optical fibers 12 of the optical fiber ribbon 10 of FIG. 1 are depicted to contact one another, the optical fibers can be spaced somewhat from one another, if so desired.

Optical fiber ribbons generally have 8, 12, 24 or more optical fibers. In many applications, however, an optical fiber ribbon must be separated into subsets. For example, in order to mount a connector upon the end portion of an optical fiber ribbon, the optical fiber ribbon must oftentimes be separated into subsets, each of which includes a smaller number of optical fibers, such as two or four optical fibers. A separate connector is then mounted upon each subset of optical fibers. In this regard, the end portion of a subset of optical fibers to be connecterized is stripped of the common matrix coating and the primary and secondary coatings are removed from the optical fibers to expose the core and cladding of the optical fibers. A connector can then be mounted upon the end portions of the optical fibers.

In order to separate the optical fiber ribbon into subsets, the optical fiber ribbon must be split. In this regard, tools are available for separating an optical fiber ribbon into multiple subsets. For example, U.S. Pat. Nos. 6,115,527 and 6,053,085 describe an advantageous separation tool for separating an optical fiber ribbon into a plurality of subsets of optical fibers. While ribbon separation tools are useful for splitting an optical fiber ribbon, technicians oftentimes do not have ready access to a ribbon separation tool, such as in instances in which the technician is installing an optical fiber ribbon in the field. In addition, technicians sometimes do not wish to expend the time required to utilize a ribbon separation tool in order to split an optical fiber ribbon. As such, technicians commonly split optical fiber ribbons into a plurality of subsets of optical fibers by merely pulling the optical fiber ribbon apart by hand. In this regard, a technician would grasp the subset of optical fibers that is to be separated from the remainder of the optical fiber ribbon with one hand, while holding the remainder of the optical fibers of the optical fiber ribbon in the other hand. The technician would then pull the optical fiber ribbon apart in order to separate the subset of optical fibers from the remainder of the optical fiber ribbon.

While the matrix coating of an optical fiber ribbon is typically sufficiently thin to permit the technician to separate the optical fiber ribbon into subsets of optical fibers by hand, the optical fiber ribbon oftentimes does not separate in the manner anticipated by the technician. In particular, the optical fiber ribbon typically splits in an irregular manner such that the matrix coating that separates the optical fibers does not split evenly between the subsets. Instead, one subset may include more of the matrix coating than the other subset. In fact, the optical fiber that extends along the edge of the subset that includes less of the matrix coating may no longer be covered by the matrix coating and may therefore be exposed and unprotected, thereby rendering the optical fiber susceptible to damage. In addition, the optical fiber that is exposed may partially separate from the remainder of the substrate.

In some instances, not only may the matrix coating separate in an irregular manner, but the optical fibers may split in an unintended manner. In this regard, the technician may desire to separate a subset of four optical fibers from the remainder of the optical fiber ribbon. Upon separating the optical fiber ribbon by hand, however, the optical fiber ribbon may actually separate into a subset having a slightly greater or lesser number of optical fibers. By way of an example in which an optical fiber ribbon having twelve optical fibers is to be separated into two subsets having eight and four optical fibers, respectively, the manual separation of the optical fiber ribbon may unfortunately produce one subset of nine optical fibers and another subset of three optical fibers. The optical fiber ribbon must then either be scrapped or the technician must take further steps in order to separate an additional optical fiber from the subset that originally included nine optical fibers such that the optical fibers can be appropriately grouped into subsets of four and eight optical fibers. Even if the optical fiber ribbon can be separated into subsets having the desired number of optical fibers, these additional steps disadvantageously consume additional time and require extra effort on behalf of the technician.

### SUMMARY OF THE INVENTION

A method of separating a lengthwise extending optical fiber ribbon into first and second lengthwise extending optical fiber ribbon subsets is therefore provided according to one aspect of the present invention. In this regard, a tape having a preferential splitting direction defining the direction in which the tape will have a propensity to split is applied to the optical fiber ribbon such that the preferential splitting direction of the tape extends in a lengthwise direction along the optical fiber ribbon, and the optical fiber ribbon and the tape are then split in the lengthwise direction in accordance with the preferential splitting direction of the tape to thereby form first and second optical fiber ribbon subsets. By guiding the separation of the optical fiber ribbon with the tape having the preferential splitting direction along which the tape will have a propensity to split, the method according to this aspect of the present invention can reliably and repeatedly separate the optical fiber ribbon into subsets having the desired number of optical fibers.

An optical fiber ribbon assembly is provided according to another aspect of the present invention that is capable of being separated into first and second optical fiber ribbon segments. The optical fiber ribbon assembly includes an optical fiber ribbon having a plurality of optical fibers extending in a lengthwise direction and a coating surrounding the plurality of optical fibers, and a tape having a preferential splitting direction that is attached to the optical fiber ribbon and that extends lengthwise therealong such that the preferential splitting direction of the tape extends in the lengthwise direction along the optical fiber ribbon. Thus, the optical fiber ribbon assembly can be reliably separated into subsets having the desired number of optical fibers since the preferential splitting direction of the tape will guide the separation of the optical fibers in a lengthwise direction along the optical fiber.

According to another aspect of the present invention, an optical fiber ribbon is provided that includes a tape extending in a lengthwise direction and having a preferential splitting direction defining the direction in which the tape will have a propensity to split, and a plurality of optical fibers attached to the tape and extending in the lengthwise direction. Since the preferential splitting direction of the tape of the optical fiber ribbon of this aspect of the present invention also extends in the lengthwise direction, the separation of the optical fiber ribbon into first and second optical fiber ribbon subsets having the desired number of optical fibers is facilitated.

A method of fabricating an optical fiber ribbon that is capable of being reliably separated into first and second optical fiber ribbon subsets having the desired number of optical fibers is also provided according to another aspect of the present invention. According to this aspect, a tape having a preferential splitting direction that defines the direction in which the tape will have a propensity to split is oriented such that the preferential splitting direction of the tape extends in a lengthwise direction, and a plurality of optical fibers are then attached to the tape so as to also extend in the lengthwise direction.

### BRIEF DESCRIPTION OF THE DRAWINGS

Having thus described the invention in general terms, reference will now be made to the accompanying drawings, which are not necessarily drawn to scale, and wherein:

FIG. 1 is a cross-sectional view of an optical fiber ribbon having twelve optical fibers;

FIG. 2 is a perspective view illustrating the application of a tape to an optical fiber ribbon according to one embodiment of the present invention;

FIG. 3 is a perspective view illustrating the separation of the optical fiber ribbon of FIG. 2 into first and second optical fiber ribbon subsets;

FIG. 4 is a cross-sectional view of an optical fiber ribbon assembly according to one embodiment of the present invention that includes an optical fiber ribbon and tapes attached to the opposed major surfaces of the optical fiber ribbon;

FIG. 5 is a perspective view of an optical fiber ribbon according to an alternative embodiment of the present invention in which the plurality of optical fibers are directly attached to the tape; and

FIG. 6 is a cross-sectional view of the optical fiber ribbon on FIG. 5.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

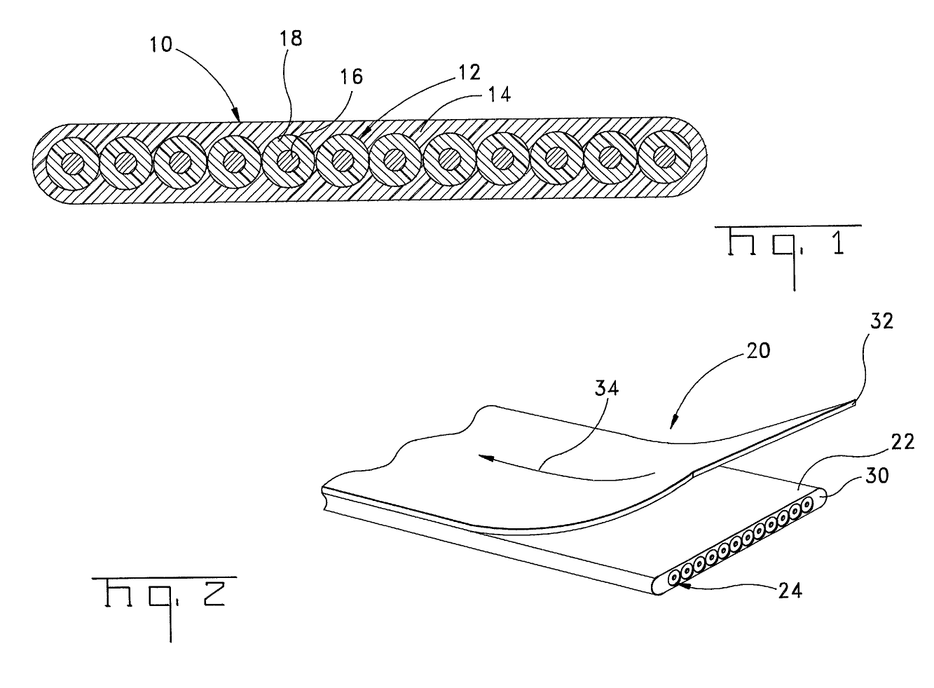

According to one aspect of the present invention, an optical fiber ribbon assembly 20 and an associated method are provided for facilitating separation of an optical fiber ribbon 22 into first and second optical fiber ribbon subsets, each of which will include a desired number of optical fibers. As shown in FIG. 2, optical fiber ribbon assembly 20 includes an optical fiber ribbon 22. As described above in conjunction with the optical fiber ribbon of FIG. 1, optical fiber ribbon 22 includes a plurality of optical fibers 24, such as 8, 12, 24 and more optical fibers extending in a lengthwise direction and disposed side-by-side in a planar relationship. While optical fibers 24 can be disposed side-by-side so as to contact one another, optical fibers 24 can also be spaced somewhat from one another, if so desired. Each optical fiber 24 typically includes a silica-based core that is operative to transmit light and is surrounded by a silica-based cladding having a lower index of refraction than the core. In FIG. 4, for example, the core and the cladding are collectively designated as 26. A soft primary coating surrounds the cladding, and a relatively rigid secondary coating surrounds the primary coating. In FIG. 4, for example, the primary and secondary coatings are collectively designated as 28. Optical fibers can be, for example, single mode or multi-mode optical fibers made commercially available by Coming, Inc. Optical fiber ribbon 22 also includes a coating 30 that surrounds the plurality of optical fibers 24. Typically, coating 30 is formed of a matrix material, such as an UV-curable acrylate material, although coating 30 can be formed of other materials, if desired.

Optical fiber ribbon assembly 20 also includes a tape 32 attached to optical fiber ribbon 22 and extending lengthwise therealong. Tape 32 typically includes a tape substrate, commonly formed of polyester, polypropylene, polyimide or the like. Although tape 32 can be attached to optical fiber ribbon 22 in various manners, tape 32 is generally adhered to optical fiber ribbon 22. Thus, tape 32 also generally includes an adhesive disposed upon the tape substrate. The adhesive is preferably a pressure-sensitive adhesive such that neither tape 32 nor optical fiber ribbon 22 need be heated in order to adhere tape 32 to optical fiber ribbon 22

According to the present invention, tape 32 has a preferential splitting direction that defines the direction in which tape 32 will have a propensity or likelihood to split. The preferential splitting direction of tape 32 can be defined in any of a variety of manners. For example, tape 32 may be formed of a polymer having a molecular orientation that defines the preferential splitting direction. Alternatively, tape 32 may have a score line or other means for creating a propensity for tape 32 to split along the preferential splitting direction. Although various tapes having a preferential splitting direction defining the direction in which the tape has a propensity to split can be utilized, one example of a tape having a preferential splitting direction is the tear-by-hand packaging tape that is commercially provided by the 3M Packaging Systems Division of St. Paul, Minn. According to the present invention, tape 32 is applied to optical fiber ribbon 22 such that the preferential splitting direction of tape 32 extends in a lengthwise direction along optical fiber ribbon 22 as indicted by arrow 34 in FIG. 2. The preferential splitting direction of tape 32 therefore preferably extends parallel to optical fibers 24. As such, tape 32 will preferentially split in the lengthwise direction.

Tape 32 may be applied during manufacture of optical fiber ribbon 22. Alternatively, tape 32 may be applied to optical fiber ribbon 22 following manufacture, either during or following installation of optical fiber ribbon. For example, tape 32 may be applied following manufacture to facilitate mid-span access procedures, splicing or connectorization of optical fiber ribbon 22, or the like.

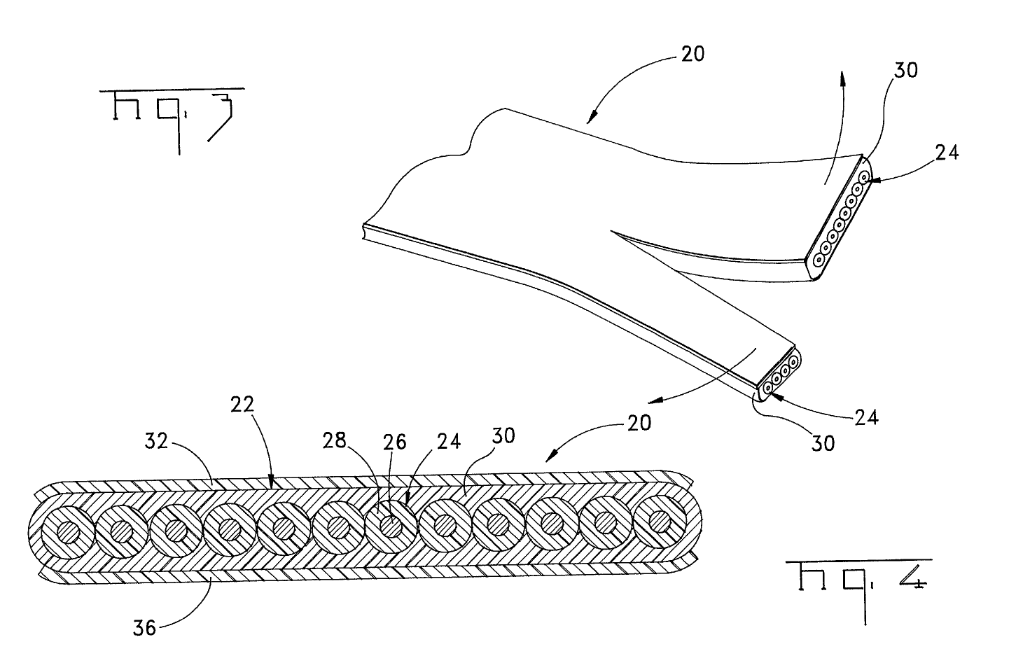

Once tape 32 has been applied to optical fiber ribbon 22, optical fiber ribbon 22 can be split into subsets having desired numbers of optical fibers 24. As shown in FIG. 3, for example, a technician can grasp the end portion of optical fiber ribbon assembly 20 such that the optical fibers to be separated into a subset are held by one hand, and the remainder of the optical fibers of optical fiber ribbon 22 are held by the other hand. In order to separate an optical fiber ribbon having twelve optical fibers into subsets having four and eight optical fibers, respectively, the technician will grasp four optical fibers in one hand, while holding the other eight optical fibers in the other hand. The technician can then pull apart optical fiber ribbon 22 as depicted by the oppositely directed force arrows, thereby splitting both optical fiber ribbon 22 and tape 32 in the lengthwise direction. As a result of having applied tape 32 to the optical fiber ribbon 22, however, optical fiber ribbon 22 and tape 32 are split in accordance with the preferential splitting direction of tape 32 such that a clean break is reliably made between the subset of four optical fibers and the remainder of optical fiber ribbon 22. By attaching tape 32 to optical fiber ribbon 22 prior to splitting optical fiber ribbon 22 into subsets of optical fibers, optical fiber ribbon 22 can be split more reliably into subsets having the desired number of optical fibers. As such, less optical fiber ribbon will be scrapped and the technician will generally spend less time attempting to reconfigure an optical fiber ribbon that has been split into subsets having the wrong number of optical fibers. Moreover, coating 30 should split more evenly between the subsets of optical fibers than in conventional designs such that each optical fiber of the resulting subsets are covered and protected by coating 30.

In order to further define the direction in which optical fiber ribbon 22 will split, optical fiber ribbon assembly 20 can include a second tape 36 that is also attached to optical fiber ribbon 22. Second tape 36 also typically includes a tape substrate, such as a polyester substrate, a polypropylene substrate, a polyimide substrate or the like, and an adhesive, such as a pressure-sensitive adhesive. Most commonly, second tape 36 is identical to tape 32. As shown in FIG. 4, optical fiber ribbon 22 has first and second opposed major surfaces. As such, tapes 32,36 can be attached to respective ones of the first and second opposed major surfaces. Both tapes have the same preferential splitting direction and are attached to optical fiber ribbon 22 such that the preferential splitting direction of tapes 32,36 extends in the lengthwise direction along optical fiber ribbon 22. Thus, optical fiber ribbon 22 can be reliably split into subsets having the desired number of optical fibers since the splitting of optical fiber ribbon 22 will be guided by the separation of optical fiber ribbon 22 and tapes 32,36 in accordance with the preferential splitting direction of tapes 32,36.

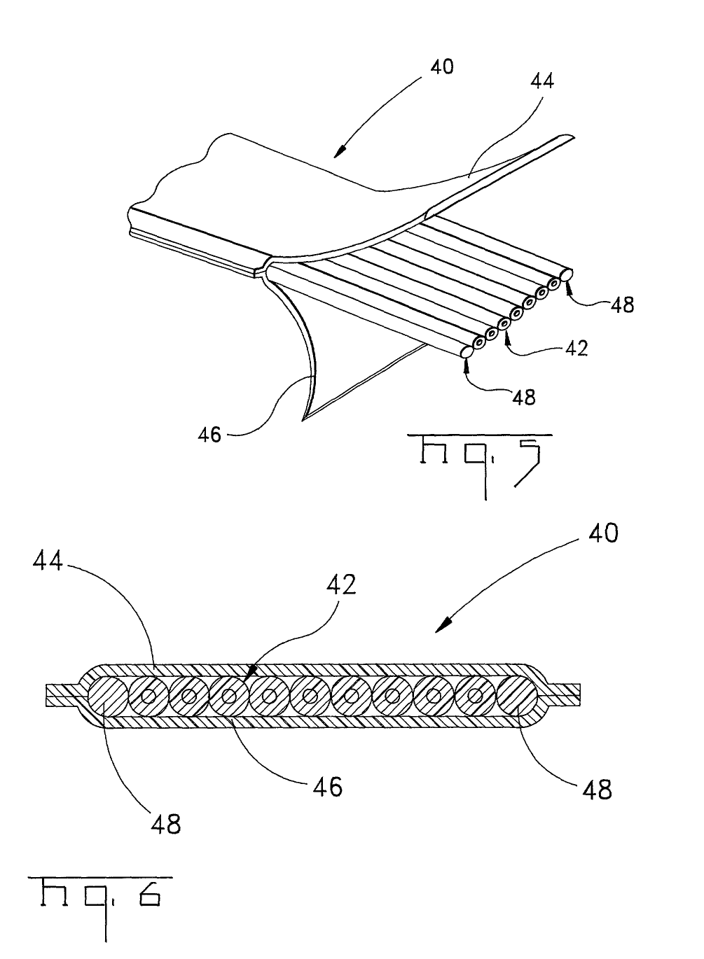

While the optical fiber ribbon described above and depicted in FIGS. 2-4 includes a coating surrounding the plurality of optical fibers, an optical fiber ribbon 40 can be formed according to another embodiment of the present invention by attaching a plurality of optical fibers 42 directly to a tape 44 such that tape 44 effectively serves as the coating. In this regard, tape 44 serves to retain optical fibers 42 in position and to protect optical fibers 42. In this embodiment depicted in FIGS. 5 and 6, optical fiber ribbon 40 includes tape 44 and a plurality of optical fibers 42 attached to tape 44. As described above, tape 44 typically includes a tape substrate, generally formed of polyester, polypropylene, polyimide or the like, and an adhesive, such as a pressure-sensitive adhesive, disposed upon the tape substrate so as to adhere tape 44 to the plurality of optical fibers 42. Both tape 44 and the plurality of optical fibers 42 preferably extend in a lengthwise direction. Moreover, tape 44 has a preferential splitting direction defining the direction in which tape 44 will preferentially split. For example, tape 44 can be the tear-by-hand packaging tape provided by 3M Packaging System Division. As described above, tape 44 is oriented such that the preferential splitting direction of tape 44 also extends in the lengthwise direction. As such, optical fiber ribbon 40 of this embodiment of the present invention can also be reliably separated into subsets having the desired numbers of optical fibers 42 since the preferential splitting direction of tape 44 will guide the separation of optical fibers 42. As such, optical fiber ribbon 40 can be cleanly separated into two or more subsets of optical fibers.

In order to protect optical fibers 42, optical fiber ribbon 40 also generally includes a substrate 46 extending lengthwise along the plurality of optical fibers and positioned opposite tape 44. As shown in FIGS. 5 and 6, optical fibers 42 can be secured between substrate 46 and tape 44. In one embodiment, substrate 46 is a second tape having the same preferential splitting direction as tape 44 and positioned so as to extend lengthwise along the plurality of optical fibers such that the preferential splitting direction of the second tape also extends in the lengthwise direction. In this embodiment, the second tape typically includes a tape substrate, such as a polyester substrate, polypropylene substrate, polyimide substrate or the like, and an adhesive, such as a pressure-sensitive adhesive, disposed upon the tape substrate for adhering the second tape to the plurality of optical fibers and, in some instances, to tape 44 attached to the other side of the optical fibers 42. By utilizing a second tape having the same preferential splitting direction, optical fibers 42 are not only protected, but the second tape can assist with the separation of optical fiber ribbon 40 into subsets having the desired number of optical fibers by further facilitating a clean break between the subset of optical fibers and the remainder of optical fiber ribbon 40. Substrate 46 need not necessarily be identical to tape 44, however, and, in fact, need not be formed of a tape at all. In a preferred embodiment, however, substrate 46 is preferably adapted to split at least as easily, if not more easily, in the lengthwise direction than tape 44. For example, substrate 46 may be formed of paper which splits more easily than tape 44. As such, substrate 46 will not obstruct or otherwise limit the ability of a technician to separate optical fiber ribbon 40 into subsets of optical fibers.

Optical fiber ribbon 40 of this embodiment is advantageously quite thin since tape 44 and substrate 46, in those embodiments including a substrate, are generally somewhat thinner than the coating of a conventional optical fiber ribbon. As such, optical fiber ribbons 40 of this embodiment can be stacked to create an array of optical fibers that is more dense than a corresponding stack of conventional optical fiber ribbons. In order to facilitate the stacking of optical fiber ribbons 40 in accordance with this embodiment, substrate 46 and/or tape 44 preferably has an outer surface facing away from the plurality of optical fibers 42 that has a roughened texture, thereby increasing the coefficient of friction of the outer surface. As such, optical fiber ribbons 40 of this embodiment can be stacked and the textured outer surface of substrate 46 and/or tape 44 can assist in maintaining the stack of optical fiber ribbons and preventing optical fiber ribbons from slipping out of the stack.

In order to increase the strength and to reduce buckling of optical fiber ribbon 40, optical fiber ribbon 40 can include one or more strength members 48. As shown in FIGS. 5 and 6, strength member(s) 48 generally extend lengthwise alongside the plurality of optical fibers 42. As such, strength members 48 are generally attached to tape 44 in the same manner described above in conjunction with optical fibers 42. While strength members 48 can be formed of various materials, strength members 48 are preferably formed of a material having a coefficient of thermal expansion that more closely approximates that of optical fibers 42 as opposed to that of tape 44. For example, strength members 48 can be formed of a glass reinforced plastic (GRP) or an aramid reinforced plastic (ARP). As such, strength members 48 will reduce, if not prevent, buckling of optical fibers 42 at lower temperatures. In this regard, lower temperatures will cause tape 44 to shrink to a greater degree than optical fibers 42. Absent strength members 48, optical fibers 42 would therefore undulate or assume a zig-zag pattern at lower temperatures to accommodate for the different rates of contraction of tape 44 and optical fibers 42. By including strength members 48, however, the buckling of optical fibers 42 at lower temperatures is reduced, if not eliminated.

As illustrated in FIG. 5, optical fiber ribbon 40 of this embodiment can therefore be fabricated by initially orienting tape 44 having a preferential splitting direction that defines the direction in which tape 44 has a propensity to split such that the preferential splitting direction extends in a lengthwise direction. A plurality of optical fibers 42 are then attached to tape 44, so as to extend in parallel in the lengthwise direction. If desired, substrate 46, such as another tape, can be positioned alongside the plurality of optical fibers 42 opposite tape 44 and attached to optical fibers 42 and/or tape 44 such that optical fibers 42 are secured between substrate 46 and tape 44, thereby protecting the optical fibers 42 and effectively forming an optical fiber ribbon 40. As a result of the preferential splitting direction of tape 44 and the orientation of tape 44 relative to optical fibers 42 such that the preferential splitting direction of tape 44 extends in the lengthwise direction, the resulting optical fiber ribbon 40 can be reliably split into two or more subsets of optical fibers 42, each of which will have the desired number of optical fibers since the preferential splitting direction of tape 44 guides the manner in which optical fiber ribbon 40 splits. As such, a straight and properly positioned split between the subset of optical fibers and the remainder of optical fiber ribbon 40 can be readily obtained.

In order to identify the optical fiber ribbon of any of the embodiments of the present invention, the substrate and/or the tape can have a predetermined color. In addition, indicia, such as the name of the supplier or the name of the particular optical fiber ribbon, can be printed upon the tape prior to attaching the tape to an optical fiber ribbon or to a plurality of optical fibers. As such, the resulting optical fiber ribbon can include preprinted indicia without requiring that indicia be printed upon the optical fiber ribbon following assembly of the optical fiber ribbon. As such, attenuation sometimes created by printing upon the coating of a conventional optical fiber ribbon can be eliminated.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method of separating a lengthwise extending optical fiber ribbon into first and second lengthwise extending optical fiber ribbon subsets, the method comprising:
applying a tape to the optical fiber ribbon, wherein the tape has a preferential splitting direction defining a direction in which the tape has a propensity to split, and wherein applying the tape comprises applying the tape to the optical fiber ribbon such that the preferential splitting direction of the tape extends in a lengthwise direction along the optical fiber ribbon; and
splitting both the optical fiber ribbon and the tape in the lengthwise direction in accordance with the preferential splitting direction of the tape to thereby form first and second lengthwise extending optical fiber ribbon subsets.

2. A method according to claim 1 wherein splitting both the optical fiber ribbon and the tape in the lengthwise direction comprises guiding separation of the optical fiber ribbon with the tape in accordance with the preferential splitting direction of the tape.

3. A method according to claim 1 wherein the tape comprises a tape substrate and an adhesive disposed upon the tape substrate, and wherein applying the tape to the optical fiber ribbon further comprises adhering the optical fiber ribbon to the substrate.

4. A method according to claim 1 wherein the optical fiber ribbon has first and second opposed major surfaces, wherein applying the tape to the optical fiber ribbon further comprises applying first and second tapes having the same preferential splitting direction to the first and second surfaces of the optical fiber ribbon, respectively, and wherein applying the first and second tapes comprises applying the first and second tapes to the optical fiber ribbon such that the preferential splitting direction of both the first and second tapes extends in the lengthwise direction along the optical fiber ribbon.

5. An optical fiber ribbon assembly capable of being separated into first and second optical fiber ribbon subsets, the optical fiber ribbon assembly comprising:
an optical fiber ribbon comprising a plurality of optical fibers extending in a lengthwise direction and a coating surrounding the plurality of optical fibers; and
a tape attached to optical fiber ribbon and extending lengthwise therealong, said tape having a preferential splitting direction defining a direction in which the tape has a propensity to split, said tape attached to the optical fiber ribbon such that the preferential splitting direction extends in the lengthwise direction along said optical fiber ribbon.

6. An optical fiber ribbon assembly according to claim 5 wherein the tape comprises a tape substrate and an adhesive disposed upon the tape substrate for adhering the tape to the optical fiber ribbon.

7. An optical fiber ribbon assembly according to claim 5 wherein the optical fiber ribbon has first and second opposed major surfaces, wherein the tape is attached to the first surface of the optical fiber ribbon, and wherein the optical fiber ribbon assembly further comprises a second tape having the same preferential splitting direction and attached to the second surface of the optical fiber ribbon such that the preferential splitting direction of the second tape also extends in the lengthwise direction along the optical fiber ribbon.

8. An optical fiber ribbon comprising:
a tape extending in a lengthwise direction and having a preferential splitting direction defining a direction in which the tape has a propensity to split; and
a plurality of optical fibers attached to said tape and extending in the lengthwise direction,
wherein the preferential splitting direction of the tape also extends in the lengthwise direction in order to facilitate separation of the optical fiber ribbon into first and second lengthwise extending optical fiber ribbon subsets.

9. An optical fiber ribbon according to claim 8 further comprising a substrate extending lengthwise along said plurality of optical fibers opposite said tape so as to secure said plurality of optical fibers between said substrate and said tape.

10. An optical fiber ribbon according to claim 9 wherein said substrate comprises a second tape having the same preferential splitting direction and extending lengthwise along said plurality of optical fibers such that the preferential splitting direction of the second tape also extends in the lengthwise direction.

11. An optical fiber ribbon according to claim 9 wherein said substrate is adapted to split more easily in the lengthwise direction than said tape.

12. An optical fiber ribbon according to claim 9 wherein a surface of at least one of said tape and said substrate that faces away from said plurality of optical fibers is textured.

13. An optical fiber ribbon according to claim 9 wherein at least one of said tape and said substrate has a predetermined color to identify the optical fiber ribbon.

14. An optical fiber ribbon according to claim 8 wherein at least one of said tape and said substrate comprises printed indicia.

15. An optical fiber ribbon according to claim 8 further comprising at least one strength member extending lengthwise alongside said plurality of optical fibers.

16. An optical fiber ribbon according to claim 8 wherein said tape comprises a tape substrate and an adhesive disposed upon the tape substrate for adhering said tape to said plurality of optical fibers.

17. A method of fabricating an optical fiber ribbon capable of being separated into first and second optical fiber ribbon subsets, the method comprising:
orienting a tape having a preferential splitting direction that defines a direction in which the tape has a propensity to split such that the preferential splitting direction extends in a lengthwise direction; and
attaching a plurality of optical fibers to the tape so as to also extend in the lengthwise direction.

18. A method according to claim 17 further comprising:
positioning a substrate in the lengthwise direction alongside the plurality of optical fibers opposite the tape; and
securing the substrate to at least one of the tape and the plurality of optical fibers so as to secure the plurality of optical fibers between the substrate and the tape.

19. A method according to claim 18 wherein the substrate comprises a second tape having the same preferential splitting direction, and wherein positioning the substrate comprises extending the second tape in the lengthwise direction alongside said plurality of optical fibers such that the preferential splitting direction of the second tape also extends in the lengthwise direction.

20. A method according to claim 18 further comprising selecting the substrate such that the substrate is adapted to split more easily in the lengthwise direction than the tape.

21. A method according to claim 18 further comprising selecting at least one of the tape and the substrate to have a surface that faces away from the plurality of optical fibers that is textured.

22. A method according to claim 18 further comprising selecting at least one of the tape and the substrate to have a predetermined color to identify the optical fiber ribbon.

23. A method according to claim 18 further comprising printing indicia upon at least one of the tape and the substrate.

24. A method according to claim 17 further comprising positioning at least one strength member alongside said plurality of optical fibers.

25. A method according to claim 17 wherein the tape comprises a tape substrate and an adhesive disposed upon the tape substrate, and wherein attaching the plurality of optical fibers to the tape comprises adhering the tape to the plurality of optical fibers.
